(19) United States
(12) Patent Application Publication
(10) Pub. No.: US 2022/0360796 A1
(43) Pub. Date: Nov. 10, 2022

(54) METHOD AND APPARATUS FOR RECOGNIZING ACTION, DEVICE AND MEDIUM

(71) Applicant: Beijing Baidu Netcom Science Technology Co., Ltd., Beijing (CN)

(72) Inventors: Desen ZHOU, Beijing (CN); Jian Wang, Beijing (CN); Hao Sun, Beijing (CN)

(21) Appl. No.: 17/870,660

(22) Filed: Jul. 21, 2022

(30) Foreign Application Priority Data
Jul. 30, 2021 (CN) 202110872867.6

(51) Int. Cl. H04N 19/172; H04N 19/132

(52) U.S. Cl. CPC H04N 19/172; H04N 19/132

(57) ABSTRACT

A method and apparatus for recognizing an action. The method includes: acquiring a target video; determining action categories corresponding to the target video; determining, for each action category, a pre-action-conversion video frame and post-action-conversion video frame corresponding to the action category from the target video; and determining a number of actions corresponding to the each action category based on the pre-action-conversion video frame and post-action-conversion video frame corresponding to the each action category.

### CROSS-REFERENCE TO RELATED APPLICATIONS

This patent application claims the priority of Chinese Patent Application No. 202110872867.6, filed on Jul. 30, 2021, and entitled “Method and Apparatus for Recognizing Action, Device, Medium and Product”, the entire content of which is herein incorporated by reference.

### TECHNICAL FIELD

The present disclosure relates to the field of artificial intelligence technology, and specifically to the computer vision and deep learning technologies, and can be used in smart city and smart traffic scenarios.

### BACKGROUND

At present, a human action video contains different kinds of actions, and it is required to determine the number of actions of these different kinds of actions in the human action video.

### SUMMARY

Embodiments of the present disclosure provides a method and apparatus for recognizing an action, a device, and a medium.

According to a first aspect of the present disclosure, a method for recognizing an action is provided. The method includes: acquiring a target video; determining action categories corresponding to the target video; determining, for each action category, a pre-action-conversion video frame and post-action-conversion video frame corresponding to the action category from the target video; and determining a number of actions corresponding to the each action category based on the pre-action-conversion video frame and post-action-conversion video frame corresponding to the each action category.

According to another aspect of the present disclosure, an apparatus for recognizing an action is provided. The apparatus includes: a video acquiring unit, configured to acquire a target video; a category determining unit, configured to determine action categories corresponding to the target video; a conversion frame determining unit, configured to determine, for each action category, a pre-action-conversion video frame and post-action-conversion video frame corresponding to the action category from the target video; and an action counting unit, configured to determine a number of actions corresponding to the each action category based on the pre-action-conversion video frame and post-action-conversion video frame corresponding to the each action category.

According to another aspect of the present disclosure, an electronic device is provided. The electronic device includes: at least one processor; and a memory communicatively connected to the at least one processor. The memory stores an instruction executable by the at least one processor, and the instruction when executed by the at least one processor, causes the at least one processor to perform the method for recognizing an action.

According to another aspect of the present disclosure, a non-transitory computer readable storage medium storing a computer instruction is provided. The computer instruction is used to cause a computer to perform the method for recognizing an action.

It should be understood that the content described in this part is not intended to identify key or important features of the embodiments of the present disclosure, and is not used to limit the scope of the present disclosure. Other features of the present disclosure will be easily understood through the following description.

### BRIEF DESCRIPTION OF THE DRAWINGS

The accompanying drawings are used for a better understanding of the scheme, and do not constitute a limitation to the present disclosure.

FIG. 1 is a diagram of an exemplary system architecture in which an embodiment of the present disclosure may be applied;

FIG. 2 is a flowchart of a method for recognizing an action according to an embodiment of the present disclosure;

FIG. 3 is a schematic diagram of an application scenario of the method for recognizing an action according to an embodiment of the present disclosure;

FIG. 4 is a flowchart of the method for recognizing an action according to another embodiment of the present disclosure;

FIG. 5 is a schematic structural diagram of an apparatus for recognizing an action according to an embodiment of the present disclosure;

FIG. 6 is a block diagram of an electronic device used to implement the method for recognizing an action according to embodiments of the present disclosure.

### DETAILED DESCRIPTION OF EMBODIMENTS

Exemplary embodiments of the present disclosure are described below in combination with the accompanying drawings, and various details of the embodiments of the present disclosure are included in the description to facilitate understanding, and should be considered as exemplary only. Accordingly, it should be recognized by one of ordinary skill in the art that various changes and modifications may be made to the embodiments described herein without departing from the scope and spirit of the present disclosure. Also, for clarity and conciseness, descriptions for well-known functions and structures are omitted in the following description.

It should be noted that the embodiments in the present disclosure and the features in the embodiments may be combined with each other on a non-conflict basis. The present disclosure will be described below in detail with reference to the accompanying drawings and in combination with the embodiments.

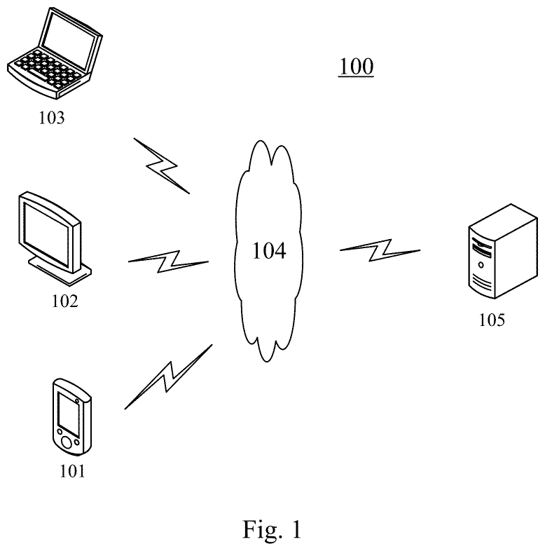

As shown in FIG. 1, a system architecture 100 may include terminal devices 101, 102 and 103, a network 104 and a server 105. The network 104 serves as a medium providing a communication link between the terminal devices 101, 102 and 103 and the server 105. The network 104 may include various types of connections, for example, wired or wireless communication links, or optical fiber cables.

A user may use the terminal devices 101, 102 and 103 to interact with the server 105 through the network 104, to receive or send a message, etc. The terminal devices 101, 102 and 103 may be electronic devices such as a mobile phone, a computer and a tablet. The terminal devices 101, 102 and 103 may acquire an action video locally or from an other electronic device with which a connection is established. In a scenario where the number of actions corresponding to each action category in the action video is determined, the terminal devices 101, 102 and 103 may transmit the action video to the server 105 through the network 104 to cause the server 105 to perform an action number determination operation, and receives the number of the actions of the each category in the action video that is returned by the server 105. Alternatively, the terminal devices 101, 102 and 103 may also perform the action number determination operation on the action video, to obtain the number of the actions of the each category in the action video.

The terminal devices 101, 102 and 103 may be hardware or software. When being the hardware, the terminal devices 101, 102 and 103 may be various electronic devices, the electronic devices including, but not limited to, a television, a smart phone, a tablet computer, an e-book reader, a vehicle-mounted computer, a laptop portable computer, a desktop computer, and the like. When being the software, the terminal devices 101, 102 and 103 may be installed in the above listed electronic devices. The terminal devices may be implemented as a plurality of pieces of software or a plurality of software modules (e.g., software or software modules for providing a distributed service), or may be implemented as a single piece of software or a single software module, which will not be specifically limited here.

The server 105 may be a server providing various services. For example, the server 105 may acquire a target video transmitted by the terminal devices 101, 102 and 103, and determine, for the each action category corresponding to the target video, a corresponding pre-action-conversion video frame and a corresponding post-action-conversion video frame from the target video. The server 105 may determine the number of actions corresponding to the each action category based on the pre-action-conversion video frame and post-action-conversion video frame corresponding to the each action category, and return the number of the actions of the each action category to the terminal devices 101, 102 and 103.

It should be noted that the server 105 may be hardware or software. When being the hardware, the server 105 may be implemented as a distributed server cluster composed of a plurality of servers, or may be implemented as a single server. When being the software, the server 105 may be implemented as a plurality of pieces of software or a plurality of software modules (e.g., software or software modules for providing a distributed service), or may be implemented as a single piece of software or a single software module, which will not be specifically limited here.

It should also be noted that the method for recognizing an action provided in the embodiment of the present disclosure may be performed by the terminal devices 101, 102 and 103, or performed by the server 105. Correspondingly, the apparatus for recognizing an action may be provided in the terminal devices 101, 102 and 103, or provided in the server 105.

It should be appreciated that the numbers of the terminal devices, the networks, and the servers in FIG. 1 are merely illustrative. Any number of terminal devices, networks, and servers may be provided based on actual requirements.

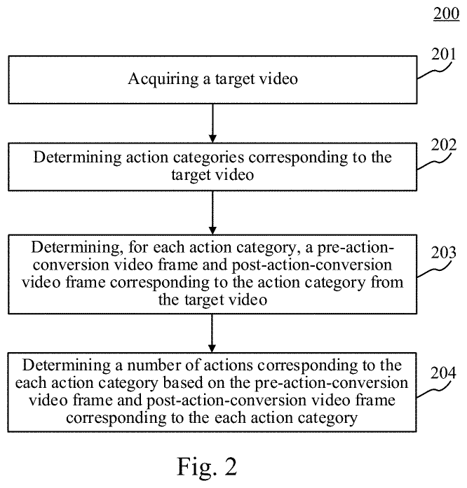

Further referring to FIG. 2, FIG. 2 illustrates a flow 200 of a method for recognizing an action according to an embodiment of the present disclosure. The method for recognizing an action in this embodiment includes the following steps.

Step 201, acquiring a target video.

In this embodiment, an executing body (e.g., the terminal devices 101, 102 and 103 and the server in FIG. 1) of the method for recognizing an action may acquire a locally stored target video on which action counting needs to be performed, or acquire a target video on which action counting needs to be performed from an other electronic device with which a connection is pre-established. Here, the target video contains an action of a specified object, and the specified object may be various objects such as a human body, a motor vehicle and a non-motor vehicle, which is not limited in this embodiment. The action may include various actions such as a squat of the human body and a turn-around of the vehicle, which is not limited in this embodiment.

Step 202, determining action categories corresponding to the target video.

In this embodiment, the executing body may use an action category on which action counting needs to be performed as each action category corresponding to the target video. Specifically, the executing body may first acquire a preset action counting requirement, analyze the action counting requirement, and determine the each action category on which the action counting needs to be performed. The action category here may be an action category for a certain type of specific object (e.g., an action category for the human body), or an action category for at least two types of objects (e.g., the action category for the human body and the vehicle). The setting for the specific action category may be determined according to an actual counting requirement, which is not limited in this embodiment. Alternatively, based on an image analysis on video frames of the target video, the executing body may also obtain each action category existing in the video frames, to use the each action category as the each action category corresponding to the above target video.

Step 203, determining, for each action category, a pre-action-conversion video frame and post-action-conversion video frame corresponding to the action category from the target video.

In this embodiment, the executing body may first determine the video frames corresponding to the target video, and then determine, based on an image recognition technology, the action category corresponding to the each video frame in the target video, and whether the each video frame under the action category corresponding to the each video frame belongs to an image before a conversion of an action or an image after the conversion of the action. Then, the executing body may determine, for the each action category, the video frame before the conversion of the action corresponding to the action category from the video frames, that is, determine the pre-action-conversion video frame corresponding to the action category. Moreover, the executing body may determine, for the each action category, the video frame after the conversion of the action corresponding to the action category from the video frames, that is, determine the post-action-conversion video frame corresponding to the action category. Here, the pre-action-conversion video frame refers to a video frame corresponding to an initial state of the action corresponding to the action category, and the post-action-conversion video frame refers to a video frame corresponding to an end state of the action corresponding to the action category. For example, for the case where the action category refers to a squat category, the image before the conversion of the action corresponding to the action category is a standing image, and the image after the conversion of the action corresponding to the action category is an image of squatting to the end. At this time, the pre-action-conversion video frame corresponding to the action category and determined from the target video is the video frame corresponding to the standing image in the target video, and the post-action-conversion video frame corresponding to the action category and determined from the target video is the video frame corresponding to the image of squatting to the end in the target video.

Step 204, determining the number of actions corresponding to the each action category based on the pre-action-conversion video frame and post-action-conversion video frame corresponding to the each action category.

In this embodiment, for the each action category, the executing body may determine the number of the actions corresponding to the action category based on the pre-action-conversion video frame and post-action-conversion video frame corresponding to the action category.

In some alternative implementations of this embodiment, determining the number of actions corresponding to the each action category based on the pre-action-conversion video frame and post-action-conversion video frame corresponding to the each action category may include: determining, for the each action category, frame positions of the pre-action-conversion video frame and post-action-conversion video frame corresponding to the action category in the target video; traversing the pre-action-conversion video frame and post-action-conversion video frame corresponding to the action category in sequence according to the frame positions from front to back; and during the traversing, in response to detecting that a next traversal frame of the pre-action-conversion video frame corresponding to the action category is the post-action-conversion video frame and in response to frame positions of the pre-action-conversion video frame and the next traversal frame indicating that the video frames are frames adjacent to each other, increasing the number of the actions corresponding to the action category by 1, where an initial value of the number of the actions is 0, and the number of the actions corresponding to the action category is obtained until the traversing ends.

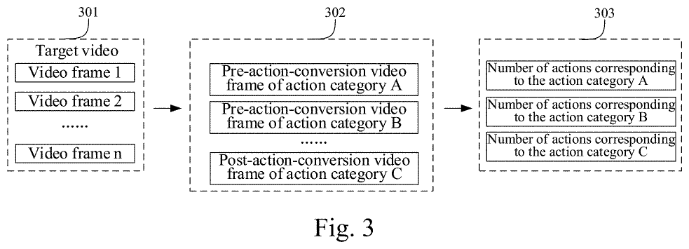

Further referring to FIG. 3, FIG. 3 is a schematic diagram of an application scenario of the method for recognizing an action according to this embodiment. In the application scenario of FIG. 3, the executing body may first acquire a target video 301 on which action counting needs to be performed, and the target video 301 includes a video frame 1, a video frame 2, . . . a video frame n. The executing body may first determine action categories corresponding to the target video 301, and the action categories are specifically an action category A, an action category B, and an action category C. Afterwards, for each action category, a pre-action-conversion video frame and post-action-conversion video frame corresponding to the action category may be determined from then video frames corresponding to the target video 301, to obtain the pre and post-action-conversion video frames 302 corresponding to the target video 301. The video frames 302 may specifically include a pre-action-conversion video frame corresponding to the action category A, a post-action-conversion video frame corresponding to the action category A, a pre-action-conversion video frame corresponding to the action category B, a post-action-conversion video frame corresponding to the action category B, a pre-action-conversion video frame corresponding to the action category C, a post-action-conversion video frame corresponding to the action category C, etc. Then, based on the pre and post-action-conversion video frames 302, for the each action category, the executing body may determine the number of actions of the action category according to the pre-action-conversion video frame and post-action-conversion video frame of the action category, to obtain numbers 303 of actions corresponding to the action categories. Here, the numbers 303 of the actions corresponding to the action categories may include the number of actions corresponding to the action category A, the number of actions corresponding to the action category B and the number of actions corresponding to the action category C.

According to the method for recognizing an action provided in the above embodiment of the present disclosure, for the each action category corresponding to the target video, the pre-action-conversion video frame and post-action-conversion video frame corresponding to the action category can be determined from the target video, and the number of the actions corresponding to the each action category can be determined based on the pre-action-conversion video frame and post-action-conversion video frame corresponding to the each action category. According to this process, numbers of actions corresponding to a plurality of action categories can be determined at the same time based on the pre-action-conversion video frame and post-action-conversion video frame corresponding to the each action category, which can improve the efficiency of determining the numbers of the actions.

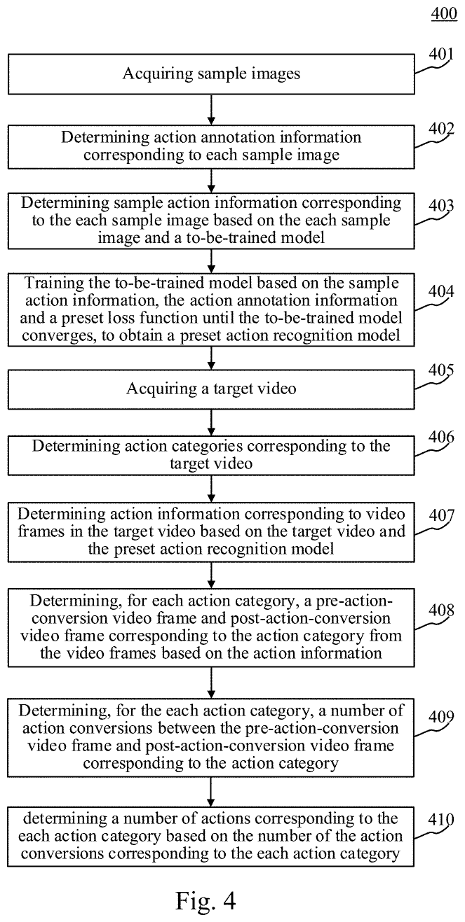

Further referring to FIG. 4, FIG. 4 illustrates a flow 400 of a method for recognizing an action according to another embodiment of the present disclosure. As shown in FIG. 4, the method for recognizing an action in this embodiment may include the following steps.

Step 401, acquiring sample images.

In this embodiment, for each video frame in a target video, the executing body may determine action information corresponding to the video frame according to an action recognition model, for example, obtain the action information corresponding to the video frame according to an action recognition performed on the each video frame. The action information is used to indicate an action category to which the video frame belongs, and indicate whether the video frame belongs to a pre-action-conversion video frame or a post-action-conversion video frame under the action category. Here, the training for the action recognition model may be performed by means of steps 401-404. The executing body first acquires a sample image used to train the action recognition model, and the sample image contains an action of a specified object.

In some alternative implementations of this embodiment, acquiring sample images includes: determining a category quantity corresponding to action categories; and acquiring the sample images corresponding to the action categories based on a target parameter, the target parameter including at least one of: the category quantity, a preset action angle, a preset distance parameter, or an action conversion parameter.

In this implementation, the executing body may first determine the category quantity of the action categories on which the counting needs to be performed, and then, the executing body may acquire the sample image based on any combination of the category quantity, the preset action angle, the preset distance parameter and the action conversion parameter. Here, the preset action angle may be any combination of 0 degree, 45 degrees, 90 degrees, 135 degrees and 180 degrees, or may be other numerical values, which is not limited in this embodiment. The preset distance parameter refers to a parameter of a photographing distance from the specified object. For example, several distance values may be selected as preset distance parameters according to the photographing distance from the specified object from far to near. Moreover, the action conversion parameter may include a pre-action-conversion image parameter and a post-action-conversion image parameter. Acquiring the sample image in this way can acquire sample images of different angles and distances before a conversion of an action corresponding to the each action category, and sample images of different angles and distances after the conversion of the action corresponding to the each action category, which can improve the comprehensiveness of the sample images.

Step 402, determining action annotation information corresponding to each sample image.

In this embodiment, after acquiring sample images, the executing body may determine the action annotation information corresponding to each sample image. Here, the action annotation information is used to annotate a real action category and a real action conversion category of the sample image. Here, the real action conversion category is a pre-action-conversion category or a post-action-conversion category. Moreover, the action annotation information may be manually annotated and stored. Alternatively, the action annotation information may only include the real action category, and do not include the real action conversion category. In this case, the action annotation information may be determined and obtained by analyzing the image feature of the sample image based on an existing action recognition approach.

Step 403, determining sample action information corresponding to the each sample image based on the each sample image and a to-be-trained model.

In this embodiment, the executing body may input the each sample image into the to-be-trained model, and obtain the sample action information corresponding to the sample image. The to-be-trained model here may be a neural network model. Moreover, preferably, after acquiring the each sample image, the executing body may input the sample image into a preset key point recognition model to obtain a pose key point corresponding to the each sample image. The pose key point is used to describe the pose information of the specified object in the sample image, for example, may include each skeleton key point. At this time, the to-be-trained model may use a graph convolutional neural network model. By inputting the each sample image into the graph convolutional neural network model, the graph convolutional neural network model may construct connection information of each pose key point based on the pose key point corresponding to the sample image. For example, for the case where the pose key point includes “arm” and “elbow,” at this time, the graph convolutional neural network model may construct a connection relationship between the “arm” and the “elbow.” After that, the graph convolutional neural network model may determine a feature vector corresponding to the each pose key point based on a recognition performed on the pose key point of the each sample image. The feature vector here may include a vector of dimensions of a numerical value such as 128 and 256, and the specific numerical value of the dimension is not limited in this embodiment. For the each sample image, a pooling operation is performed on the feature vector corresponding to the each pose key point in the sample image, and thus, the feature vector corresponding to the sample image can be obtained. Then, based on the feature vector corresponding to the sample image, the executing body outputs a probability that the sample image belongs to the pre-action-conversion video frame corresponding to the each action category and a probability that the sample image belongs to the post-action-conversion video frame corresponding to the each action category, and determines the sample action information corresponding to the sample image based on these probabilities. Moreover, for the each action category, normalization processing may further be performed on these probabilities by using a softmax function (Softmax logical regression) to obtain the probabilities after the normalization processing. In the probabilities after the normalization processing, the sum of the probability that the sample image belongs to the pre-action-conversion video frame corresponding to each action category and the probability that the sample image belongs to the post-action-conversion video frame corresponding to each action category is 1.

In some alternative implementations of this embodiment, determining sample action information corresponding to the each sample image based on the each sample image and the to-be-trained model includes: determining, for the each sample image, sample probability information that the sample image belongs to the pre-action-conversion video frame and post-action-conversion video frame corresponding to the each action category, based on the sample image and the to-be-trained model; and determining the sample action information based on the sample probability information.

In this implementation, the executing body may input the sample image into the to-be-trained model, to obtain the sample probability information that the sample image belongs to the pre-action-conversion video frame and post-action-conversion video frame corresponding to each action category, the sample probability information being outputted by the trained model. Preferably, the sample probability information here refers to the above probabilities after the normalization processing. Then, the executing body may determine the action category to which the sample image most likely belongs, based on the sample probability information. Alternatively, the executing body may also determine, based on the sample probability information, the action conversion category under the action category to which the sample image is most likely to belong. The action conversion category refers to the pre-action-conversion video frame or the post-action-conversion video frame. The sample action information may be a predicted action category and a predicted action conversion category of the sample image. Here, the predicted action conversion category is a pre-action-conversion category or a post-action-conversion category.

Step 404, training the to-be-trained model based on the sample action information, the action annotation information and a preset loss function until the to-be-trained model converges, to obtain a preset action recognition model.

In this embodiment, the training for the action recognition model may be based on simultaneous training for recognitions on actions of a plurality of different action categories. Specifically, after obtaining the sample action information, the executing body may input the sample action information and the action annotation information into the loss function corresponding to the action category, to perform backpropagation, to train the to-be-trained model. Here, the preset loss function may include different loss functions corresponding to different action categories, or may be the same loss function corresponding to different action categories. In the model training stage, according to the action category, the executing body may plug the sample action information and action annotation information corresponding to the action category in the sample image into the loss function. Moreover, when the sample action information corresponding to the action category in the sample image is plugged into the loss function, a probability that the sample image belongs to a pre-action-conversion video frame of the real action category and a probability that the sample image belongs to a post-action-conversion video frame of the real action category may be determined based on the sample action information. The two probability values and the action annotation information are plugged into the loss function, thus implementing more accurate training for the model.

Step 405, acquiring a target video.

In this embodiment, step 405 is described with reference to the detailed description for step 201, and thus will not be repeatedly described here.

Step 406, determining action categories corresponding to the target video. In this embodiment, step 406 is described with reference to the detailed description for step 202, and thus will not be repeatedly described here.

Step 407, determining action information corresponding to video frames in the target video based on the target video and the preset action recognition model.

In this embodiment, after acquiring the target video, preferably, the executing body determines a pose key point of a specified object in each video frame in the target video based on the preset key point recognition model and the target video, and then, determines probability information that each image frame belongs to the video frames before and after the conversion of the action corresponding to each action category, based on the pose key point and an action recognition model constructed using a graph neural network model. Then, the action information is determined based on the probability information. Here, the action information refers to an action category which the video frame has a high probability of belonging to, and a frame category under the action category which the video frame has the high probability of belonging to. The frame category includes the pre-action-conversion video frame and the post-action-conversion video frame.

In some alternative implementations of this embodiment, determining action information corresponding to video frames in the target video based on the target video and the preset action recognition model includes: determining, for each video frame in the target video, probability information that the video frame belongs to the pre-action-conversion video frame and post-action-conversion video frame corresponding to the each action category, based on the video frame and the preset action recognition model; and determining the action information based on the probability information.

In this implementation, based on the probability information, the executing body may determine, in response to determining that a probability of the video frame belonging to a pre-action-conversion video frame under a target action category is greater than a preset first threshold, the action information of the video frame as the pre-action-conversion video frame under the target action category. In response to determining that the probability of the video frame belonging to the pre-action-conversion video frame under the target action category is less than a preset second threshold, the action information of the video frame is determined as the post-action-conversion video frame under the target action category. Here, the sum of the first threshold and the second threshold is 1. Alternatively, the executing body may also determine, in response to determining that a probability of the video frame belonging to the post-action-conversion video frame under the target action category is greater than a preset third threshold, the action information of the video frame as the post-action-conversion video frame under the target action category.

Step 408, determining, for each action category, a pre-action-conversion video frame and post-action-conversion video frame corresponding to the action category from the video frames based on the action information.

In this embodiment, the action information is used to identify the action category corresponding to the video frames and the action conversion category under the action category, and the action conversion category includes the pre-action-conversion video frame and the post-action-conversion video frame. Therefore, the executing body may determine, from the video frames, the pre-action-conversion video frame and post-action-conversion video frame corresponding to the action category, based on an analysis on the action information.

Step 409, determining, for the each action category, the number of action conversions between the pre-action-conversion video frame and post-action-conversion video frame corresponding to the action category.

In this embodiment, the number of the action conversions may refer to the number of conversions from the pre-action-conversion video frame to the post-action-conversion video frame, or the number of conversions from the post-action-conversion video frame to the pre-action-conversion video frame, which is not limited in this embodiment.

Step 410, determining the number of actions corresponding to each action category based on the number of the action conversions corresponding to each action category.

In this embodiment, the executing body may determine the number of the action conversions between the pre-action-conversion video frame and post-action-conversion video frame of the each action category as the number of the actions corresponding to the action category.

According to the method for recognizing an action provided in the above embodiment of the present disclosure, the action information of the video frame may further be determined based on the action recognition model. Then, the pre-action-conversion video frame and post-action-conversion video frame are determined based on the action information. Preferably, the action recognition model may also be constructed using the graph neural network model, thereby improving the accuracy of the action information recognition. Moreover, in the stage of training the action recognition model, unified training for many different action categories can be realized, without having to separately train a model for different action categories, which improves the efficiency of training the model. In addition, in the stage of training the model, the sample image is used in consideration of various parameters such as the quantity of action categories, an action angle, a distance, and an action conversion, which improves the comprehensiveness of the sample image, thus further improves the model training effect. In addition, the number of the action conversions between the pre-action-conversion video frame and post-action-conversion video frame corresponding to the each action category is used as the number of the actions corresponding to the action category, which can further improve the accuracy of determining the number of the actions.

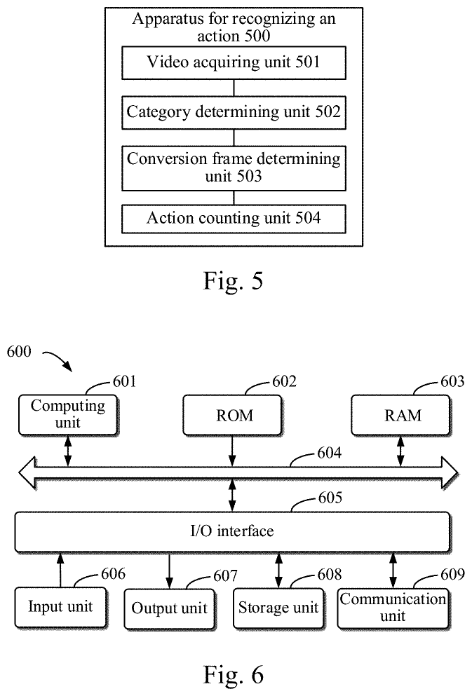

Further referring to FIG. 5, as an implementation of the method shown in the above drawings, an embodiment of the present disclosure provides an apparatus for recognizing an action. The embodiment of the apparatus corresponds to the embodiment of the method shown in FIG. 2. The apparatus may be applied in an electronic device such as a terminal device and a server.

As shown in FIG. 5, an apparatus 500 for recognizing an action in this embodiment includes: a video acquiring unit 501, a category determining unit 502, a conversion frame determining unit 503 and an action counting unit 504.

The video acquiring unit 501 is configured to acquire a target video.

The category determining unit 502 is configured to determine action categories corresponding to the target video.

The conversion frame determining unit 503 is configured to determine, for each action category, a pre-action-conversion video frame and post-action-conversion video frame corresponding to the action category from the target video.

The action counting unit 504 is configured to determine a number of actions corresponding to the each action category based on the pre-action-conversion video frame and post-action-conversion video frame corresponding to the each action category.

In some alternative implementations of this embodiment, the conversion frame determining unit 503 is further configured to: determine action information corresponding to video frames in the target video based on the target video and a preset action recognition model; and determine, for the each action category, the pre-action-conversion video frame and post-action-conversion video frame corresponding to the action category from the video frames based on the action information.

In some alternative implementations of this embodiment, the conversion frame determining unit 503 is further configured to: determine, for each video frame in the target video, probability information that the video frame belongs to the pre-action-conversion video frame and post-action-conversion video frame corresponding to the each action category, based on the video frame and the preset action recognition model; and determine the action information based on the probability information.

In some alternative implementations of this embodiment, the apparatus further includes: a model training unit, configured to acquire sample images; determine action annotation information corresponding to the sample images; determine sample action information corresponding to the each sample image based on the each sample image and a to-be-trained model; and train the to-be-trained model based on the sample action information, the action annotation information and a preset loss function until the to-be-trained model converges, to obtain the preset action recognition model.

In some alternative implementations of this embodiment, the model training unit is further configured to: determine a category quantity corresponding to the action categories; and acquire the sample images corresponding to the action categories based on a target parameter, the target parameter including at least one of: the category quantity, a preset action angle, a preset distance parameter, or an action conversion parameter.

In some alternative implementations of this embodiment, the model training unit is further configured to: determine, for the each sample image, sample probability information that the sample image belongs to the pre-action-conversion video frame and post-action-conversion video frame corresponding to the each action category, based on the sample image and the to-be-trained model; and determine the sample action information based on the sample probability information.

In some alternative implementations of this embodiment, the action counting unit 504 is further configured to: determine, for the each action category, a number of action conversions between the pre-action-conversion video frame and post-action-conversion video frame corresponding to the action category; and determine the number of the actions corresponding to the each action category based on the number of the action conversions corresponding to the each action category.

In this embodiment, the units 501-504 described in the apparatus 500 for recognizing an action respectively correspond to the steps in the method described with reference to FIG. 2. Accordingly, the above operations and features described for the method for recognizing an action are also applicable to the apparatus 500 and the units included therein, and thus will not be repeatedly described here.

According to an embodiment of the present disclosure, the present disclosure further provides an electronic device, a readable storage medium, and a computer program product.

FIG. 6 is a schematic block diagram of an example electronic device 600 that may be used to implement the embodiments of the present disclosure. The electronic device is intended to represent various forms of digital computers such as a laptop computer, a desktop computer, a workstation, a personal digital assistant, a server, a blade server, a mainframe computer, and other appropriate computers. The electronic device may also represent various forms of mobile apparatuses such as personal digital processing, a cellular telephone, a smart phone, a wearable device and other similar computing apparatuses. The parts shown herein, their connections and relationships, and their functions are only as examples, and not intended to limit implementations of the present disclosure as described and/or claimed herein.

As shown in FIG. 6, the electronic device 600 includes a computation unit 601, which may execute various appropriate actions and processes in accordance with a computer program stored in a read-only memory (ROM) 602 or a computer program loaded into a random access memory (RAM) 603 from a storage unit 608. The RAM 603 also stores various programs and data required by operations of the device 600. The computation unit 601, the ROM 602 and the RAM 603 are connected to each other through a bus 604. An input/output (I/O) interface 605 is also connected to the bus 604.

The following components in the electronic device 600 are connected to the I/O interface 605: an input unit 606, for example, a keyboard and a mouse; an output unit 607, for example, various types of displays and a speaker; a storage device 608, for example, a magnetic disk and an optical disk; and a communication unit 609, for example, a network card, a modem, a wireless communication transceiver. The communication unit 609 allows the device 600 to exchange information/data with an other device through a computer network such as the Internet and/or various telecommunication networks.

The computation unit 601 may be various general-purpose and/or special-purpose processing assemblies having processing and computing capabilities. Some examples of the computation unit 601 include, but not limited to, a central processing unit (CPU), a graphics processing unit (GPU), various dedicated artificial intelligence (AI) computing chips, various processors that run a machine learning model algorithm, a digital signal processor (DSP), any appropriate processor, controller and microcontroller, etc. The computation unit 601 performs the various methods and processes described above, for example, the method for recognizing an action. For example, in some embodiments, the method for recognizing an action may be implemented as a computer software program, which is tangibly included in a machine readable medium, for example, the storage device 608. In some embodiments, part or all of the computer program may be loaded into and/or installed on the device 600 via the ROM 602 and/or the communication unit 609. When the computer program is loaded into the RAM 603 and executed by the computation unit 601, one or more steps of the above method for recognizing an action may be performed. Alternatively, in other embodiments, the computation unit 601 may be configured to perform the method for recognizing an action through any other appropriate approach (e.g., by means of firmware).

The various implementations of the systems and technologies described herein may be implemented in a digital electronic circuit system, an integrated circuit system, a field programmable gate array (FPGA), an application specific integrated circuit (ASIC), an application specific standard product (ASSP), a system-on-chip (SOC), a complex programmable logic device (CPLD), computer hardware, firmware, software and/or combinations thereof. The various implementations may include: being implemented in one or more computer programs, where the one or more computer programs may be executed and/or interpreted on a programmable system including at least one programmable processor, and the programmable processor may be a particular-purpose or general-purpose programmable processor, which may receive data and instructions from a storage system, at least one input device and at least one output device, and send the data and instructions to the storage system, the at least one input device and the at least one output device.

Program codes used to implement the method of embodiments of the present disclosure may be written in any combination of one or more programming languages. These program codes may be provided to a processor or controller of a general-purpose computer, particular-purpose computer or other programmable data processing apparatus, so that the program codes, when executed by the processor or the controller, cause the functions or operations specified in the flowcharts and/or block diagrams to be implemented. These program codes may be executed entirely on a machine, partly on the machine, partly on the machine as a stand-alone software package and partly on a remote machine, or entirely on the remote machine or a server.

In the context of the present disclosure, the machine-readable medium may be a tangible medium that may include or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any appropriate combination thereof. A more particular example of the machine-readable storage medium may include an electronic connection based on one or more lines, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination thereof.

To provide interaction with a user, the systems and technologies described herein may be implemented on a computer having: a display device (such as a CRT (cathode ray tube) or LCD (liquid crystal display) monitor) for displaying information to the user; and a keyboard and a pointing device (such as a mouse or a trackball) through which the user may provide input to the computer. Other types of devices may also be used to provide interaction with the user. For example, the feedback provided to the user may be any form of sensory feedback (such as visual feedback, auditory feedback or tactile feedback); and input from the user may be received in any form, including acoustic input, speech input or tactile input.

The systems and technologies described herein may be implemented in: a computing system including a background component (such as a data server), or a computing system including a middleware component (such as an application server), or a computing system including a front-end component (such as a user computer having a graphical user interface or a web browser through which the user may interact with the implementations of the systems and technologies described herein), or a computing system including any combination of such background component, middleware component or front-end component. The components of the systems may be interconnected by any form or medium of digital data communication (such as a communication network). Examples of the communication network include a local area network (LAN), a wide area network (WAN), and the Internet.

A computer system may include a client and a server. The client and the server are generally remote from each other, and generally interact with each other through the communication network. A relationship between the client and the server is generated by computer programs running on a corresponding computer and having a client-server relationship with each other. The server may be a cloud server, a distributed system server, or a server combined with a blockchain.

It should be appreciated that the steps of reordering, adding or deleting may be executed using the various forms shown above. For example, the steps described in embodiments of the present disclosure may be executed in parallel or sequentially or in a different order, so long as the expected results of the technical schemas provided in embodiments of the present disclosure may be realized, and no limitation is imposed herein.

The above particular implementations are not intended to limit the scope of the present disclosure. It should be appreciated by those skilled in the art that various modifications, combinations, sub-combinations, and substitutions may be made depending on design requirements and other factors. Any modification, equivalent and modification that fall within the spirit and principles of the present disclosure are intended to be included within the scope of the present disclosure.

What is claimed is:

1. A method for recognizing an action, comprising:
acquiring a target video;
determining action categories corresponding to the target video;
determining, for each action category, a pre-action-conversion video frame and post-action-conversion video frame corresponding to the action category from the target video; and
determining a number of actions corresponding to the each action category based on the pre-action-conversion video frame and post-action-conversion video frame corresponding to the each action category.

2. The method according to claim 1, wherein determining, for each action category, the pre-action-conversion video frame and post-action-conversion video frame corresponding to the action category from the target video comprises:
determining action information corresponding to video frames in the target video based on the target video and a preset action recognition model; and
determining, for the each action category, the pre-action-conversion video frame and post-action-conversion video frame corresponding to the action category from the video frames based on the action information.

3. The method according to claim 2, wherein determining action information corresponding to video frames in the target video based on the target video and the preset action recognition model comprises:
determining, for each video frame in the target video, probability information that the video frame belongs to the pre-action-conversion video frame and post-action-conversion video frame corresponding to the each action category, based on the video frame and the preset action recognition model; and
determining the action information based on the probability information.

4. The method according to claim 2, wherein the preset action recognition model is trained and obtained by:
acquiring sample images;
determining action annotation information corresponding to each sample image;
determining sample action information corresponding to the each sample image based on the each sample image and a to-be-trained model; and
training the to-be-trained model based on the sample action information, the action annotation information, and a preset loss function until the to-be-trained model converges to obtain the preset action recognition model.

5. The method according to claim 4, wherein acquiring the sample images comprises:
determining a category quantity corresponding to the action categories; and
acquiring the sample images corresponding to the action categories based on a target parameter, the target parameter comprising at least one of: the category quantity, a preset action angle, a preset distance parameter, or an action conversion parameter.

6. The method according to claim 4, wherein determining sample action information corresponding to the each sample image based on the each sample image and the to-be-trained model comprises:
determining, for the each sample image, sample probability information that the sample image belongs to the pre-action-conversion video frame and post-action-conversion video frame corresponding to the each action category, based on the sample image and the to-be-trained model; and
determining the sample action information based on the sample probability information.

7. The method according to claim 1, wherein determining the number of actions corresponding to the each action category based on the pre-action-conversion video frame and post-action-conversion video frame corresponding to the each action category comprises:
determining, for the each action category, a number of action conversions between the pre-action-conversion video frame and post-action-conversion video frame corresponding to the action category; and
determining the number of the actions corresponding to the each action category based on the number of the action conversions corresponding to the each action category.

8. An electronic device, comprising:
at least one processor; and
a memory communicatively connected to the at least one processor,
wherein the memory stores an instruction executable by the at least one processor, and the instruction when executed by the at least one processor, causes the at least one processor to perform operations, the operations comprising:
acquiring a target video;
determining action categories corresponding to the target video;
determining, for each action category, a pre-action-conversion video frame and post-action-conversion video frame corresponding to the action category from the target video; and
determining a number of actions corresponding to the each action category based on the pre-action-conversion video frame and post-action-conversion video frame corresponding to the each action category.

9. The electronic device according to claim 8, wherein determining, for each action category, the pre-action-conversion video frame and post-action-conversion video frame corresponding to the action category from the target video comprises:
determining action information corresponding to video frames in the target video based on the target video and a preset action recognition model; and
determining, for the each action category, the pre-action-conversion video frame and post-action-conversion video frame corresponding to the action category from the video frames based on the action information.

10. The electronic device according to claim 9, wherein determining action information corresponding to video frames in the target video based on the target video and the preset action recognition model comprises:
determining, for each video frame in the target video, probability information that the video frame belongs to the pre-action-conversion video frame and post-action-conversion video frame corresponding to the each action category, based on the video frame and the preset action recognition model; and
determining the action information based on the probability information.

11. The electronic device according to claim 9, wherein the preset action recognition model is trained and obtained by:
acquiring sample images;
determining action annotation information corresponding to each sample image;
determining sample action information corresponding to the each sample image based on the each sample image and a to-be-trained model; and
training the to-be-trained model based on the sample action information, the action annotation information, and a preset loss function until the to-be-trained model converges to obtain the preset action recognition model.

12. The electronic device according to claim 11, wherein acquiring the sample images comprises:
determining a category quantity corresponding to the action categories; and
acquiring the sample images corresponding to the action categories based on a target parameter, the target parameter comprising at least one of: the category quantity, a preset action angle, a preset distance parameter, or an action conversion parameter.

13. The electronic device according to claim 11, wherein determining sample action information corresponding to the each sample image based on the each sample image and the to-be-trained model comprises:
determining, for the each sample image, sample probability information that the sample image belongs to the pre-action-conversion video frame and post-action-conversion video frame corresponding to the each action category, based on the sample image and the to-be-trained model; and
determining the sample action information based on the sample probability information.

14. The electronic device according to claim 8, wherein determining the number of actions corresponding to the each action category based on the pre-action-conversion video frame and post-action-conversion video frame corresponding to the each action category comprises:
determining, for the each action category, a number of action conversions between the pre-action-conversion video frame and post-action-conversion video frame corresponding to the action category; and
determining the number of the actions corresponding to the each action category based on the number of the action conversions corresponding to the each action category.

15. A non-transitory computer readable storage medium, storing a computer instruction, wherein the computer instruction when executed by a processor, causes the processor to perform operations, the operations comprising:
acquiring a target video;
determining action categories corresponding to the target video;
determining, for each action category, a pre-action-conversion video frame and post-action-conversion video frame corresponding to the action category from the target video; and
determining a number of actions corresponding to the each action category based on the pre-action-conversion video frame and post-action-conversion video frame corresponding to the each action category.

16. The non-transitory computer readable storage medium according to claim 15, wherein determining, for each action category, the pre-action-conversion video frame and post-action-conversion video frame corresponding to the action category from the target video comprises:
determining action information corresponding to video frames in the target video based on the target video and a preset action recognition model; and
determining, for the each action category, the pre-action-conversion video frame and post-action-conversion video frame corresponding to the action category from the video frames based on the action information.

17. The non-transitory computer readable storage medium according to claim 16, wherein determining action information corresponding to video frames in the target video based on the target video and the preset action recognition model comprises:
determining, for each video frame in the target video, probability information that the video frame belongs to the pre-action-conversion video frame and post-action-conversion video frame corresponding to the each action category, based on the video frame and the preset action recognition model; and
determining the action information based on the probability information.

18. The non-transitory computer readable storage medium according to claim 16, wherein the preset action recognition model is trained and obtained by:
acquiring sample images;
determining action annotation information corresponding to each sample image;
determining sample action information corresponding to the each sample image based on the each sample image and a to-be-trained model; and
training the to-be-trained model based on the sample action information, the action annotation information, and a preset loss function until the to-be-trained model converges to obtain the preset action recognition model.

19. The non-transitory computer readable storage medium according to claim 18, wherein acquiring the sample images comprises:
determining a category quantity corresponding to the action categories; and
acquiring the sample images corresponding to the action categories based on a target parameter, the target parameter comprising at least one of: the category quantity, a preset action angle, a preset distance parameter, or an action conversion parameter.

20. The non-transitory computer readable storage medium according to claim 18, wherein determining sample action information corresponding to the each sample image based on the each sample image and the to-be-trained model comprises:
determining, for the each sample image, sample probability information that the sample image belongs to the pre-action-conversion video frame and post-action-conversion video frame corresponding to the each action category, based on the sample image and the to-be-trained model; and
determining the sample action information based on the sample probability information.
